(19) United States
(12) Patent Application Publication
(10) Pub. No.: US 2018/0295420 A1
(43) Pub. Date: Oct. 11, 2018

(54) METHODS, SYSTEMS AND APPARATUS FOR MEDIA CONTENT CONTROL BASED ON ATTENTION DETECTION

(71) Applicant: THOMSON Licensing, Issy-les-Moulineaux (FR)

(72) Inventors: Mark Francis RUMREICH, Indianapolis, IN (US); Joel M. FOGELSON, Pasadena, CA (US); Thomas Edward HORLANDER, Marion, IN (US)

(21) Appl. No.: 15/756,911

(22) PCT Filed: Aug. 31, 2016
(86) PCT No.: PCT/US2016/049786

§ 371 Date: Mar. 1, 2018

Related U.S. Application Data
(60) Provisional application No. 62/212,668, filed on Sep. 1, 2015.

(51) Int. Cl. H04N 21/442; H04N 21/45; H04N 21/8547

(52) U.S. Cl. CPC H04N 21/44218; H04N 21/8547; H04N 21/4532

(57) ABSTRACT

An aspect of present principles is directed to methods, systems, apparatus and computer executable code for executing instructions to perform at least a media control operation. This may include monitoring provided media content and attention information; determining attention detection based on the attention information; evaluating a filter condition based on the attention detection and additional attention information; and providing the media control operation based on an affirmative determination of the filter condition. The methods, systems and apparatus and computer executable code may further display the media control operation.

### REFERENCE TO RELATED PROVISIONAL APPLICATION

This application claims priority from U.S. Provisional Application No. 62/212,668, entitled “Methods, Systems and Apparatus for Media Content Control Based on Attention Detection,” filed on Sep. 1, 2015, the contents of which are hereby incorporated by reference in its entirety.

### TECHNICAL FIELD

The present principles of the embodiments generally relate to a method and apparatus for displaying audio/video media content. In particular, the present principles relate to methods, systems and apparatus for media content control based on attention detection.

### BACKGROUND

Numerous electronic and computing devices display media content (e.g., image, audio and/or video content) to an audience of multiple users. However, it can be problematic when one or more of the users stop observing the media content for a period of a time. For example, there is a risk that one or more users may miss content when they leave a room while the content is being played. If a pause button is used, the remaining user(s) are subjected to idle waiting for an unknown amount of time. Alternatively, the content immediately following a pause may not be worth watching; thereby the user is subjected to unnecessary content when the pause operation is suspended. Or, trying to locate relevant content may be a time consuming and imprecise process.

### BRIEF SUMMARY OF THE DRAWINGS

The features and advantages of the present invention may be apparent from the detailed description below when taken in conjunction with the Figures described below:

FIG. 1 illustrates a schematic diagram of a system in accordance with present principles.

FIG. 2 illustrates a schematic diagram of an apparatus in accordance with present principles.

FIG. 3A illustrates a flow diagram of a method in accordance with present principles.

FIG. 3B illustrates a flow diagram of a method for providing media content control operation(s) in accordance with present principles

FIG. 4 illustrates a flow diagram of a method in accordance with present principles.

FIG. 5 illustrates a flow diagram of a method in accordance with present principles.

FIG. 6 illustrates a flow diagram of a method in accordance with present principles.

FIG. 7 illustrates a flow diagram of a method in accordance with present principles.

FIG. 8 illustrates a schematic diagram of a user interface for displaying media operation(s) in accordance with present principles.

### SUMMARY

There is a need to minimize disruption when one or more users stop observing media content. For example, there is a need for a method to prevent person(s) from missing out on media content when multiple viewers are watching the same content and one of them leaves the room while planning to return.

An aspect of present principles is directed to methods, systems, apparatus and computer executable code for executing instructions to perform at least a media control operation. This may include monitoring provided media content and attention information; determining attention detection based on the attention information; evaluating a filter condition based on the attention detection and additional attention information; and providing the media control operation based on an affirmative determination of the filter condition. The methods, systems and apparatus and computer executable code may further display the media control operation.

The additional attention information may be at least an event record or metadata. The event record information may include information regarding attention of a plurality of observers of the media content. The event record information may include at least one selected from a group of: time duration, number of observers, type of media content, time information, biometric information, observational patterns, time information, display information, and auxiliary devices.

The event record information includes at least an event record. The event record may include at least one of a time stamp relating to a time of the media content, the media content information at the time of the media content, and at least attention information of at least an observer at the time of the media content. The media content information may include an indication of how critical scene is, plot information, etc. The event record information may include a log of a plurality of event records, wherein the log is synchronized with each time stamp of each of the event records. The attention detection may be based on a determination that the observer lost attention to the media content above a threshold.

The filter condition may be affirmative if the at least an observer returned attention to the media content. The filter condition may be determined based on metadata, wherein the metadata is at least one selected from the group of time of day, day of week, weather condition, age of viewers, gender of viewers, size of viewing screen, hours of content consumed per day, geographical location, and preference profiles.

The providing the media control operation is at least an offering or activating of the media control operation. The media control operation may correspond to at least one selected from a group of rewind, pause, fast forward and time stamp jumping to a predesignated place in the media.

### DETAILED DESCRIPTION

As used herein, “media content” may be defined to include any type of media, including any type of audio, video, and/or image media content received from any source. For example, “media content” may include Internet content, streaming services (e.g., M-Go, Netflix, Hulu, Amazon), recorded video content, video-on-demand content, broadcasted content, television content, television programs (or programming), advertisements, commercials, music, movies, video clips, interactive games, network-based entertainment applications, and other media assets. Media assets may include any and all kinds of digital media formats, such as audio files, image files or video files.

An aspect of present principles relates to system(s), apparatus, and method(s) for providing for display media content control operation(s) options. In particular, an aspect of present principles relates to providing for display media content control operation(s) options based on the detection of attention changes (e.g., loss or return of attention) of one or more observers of media content.

An aspect of present principles is directed to receiving attention information regarding media content observers. For example, an aspect is directed to receiving attention information from sensors (e.g., cameras, microphones). In one example, the attention information may relate to visual and audio information for identifying whether an observer is observing the media content. In one example, attention value may be determined. For example, an attention value may be incremented by one for each gained observer and decreased by one for each lost observer. Alternatively, may determine a partial attention value for an observer based on the actions of the observer. For example, a person's attention may be measured in fractional attention units (from 1.0 to 0.9 to 0.8 . . . to zero).

An aspect of present principles relates to providing media control operations (e.g., pause, rewind) based on specific conditions, such as when a person leaves a room during a movie and subsequently returns. In one example, an aspect of present principles is directed to an apparatus (e.g., a media player, a TV, a Blu-Ray player, a digital set top box, a video game system, a computer, a tablet, a phone) that may determine and/or recognize when a person has left a room and/or a viewing area. When the person returns under specific conditions, the apparatus may offer to rewind the content to the time when the person left the room/viewing area.

An aspect of present principles relates to providing media content control operations based on information, such as: (i) a time duration that the observer(s) are not observing the media content; (ii) a number of observer(s) that are observing or are not observing the media content; (iii) a total number of observers observing the media content; (iv) type of media content being provided during the time the observer(s) are not observing the media content; (v) time information (e.g., day of week, time of day); (vi) geographic information (e.g., location, weather); (vii) observer information (e.g., age, gestures, preferences, biometric information); (viii) auxiliary devices within the observation area (e.g., phones, tablets) and the observer's interaction with such devices; (ix) display information (e.g., size); (x) observational patterns (e.g., total hours of content observed per day, average content observed per day).

An aspect of present principles relates to media control operations based on metadata. In one example, metadata may be analyzed to determine a likelihood of returning to a particular scene. For example, a rewind media control operation may be provided if metadata indicates that an absent viewer missed information essential to a plot.

An aspect of present principles is directed to analyzing metadata to determine whether to provide a media control operation. Such metadata may include time of day, day of week, weather condition, age of viewers, gender of viewers, size of viewing screen, hours of TV watched per day, geographical location, and the like. For example, a rewind media control operation may be provided based on a determination that the viewers are absent during a late time of day (e.g., after 9 p.m.). Based on a condition determination (e.g., such as when a viewer returns), a log of metadata may be checked for any high interest events. High interest events may include plot twists in a drama, plays or scoring events in sports content, and the like.

The metadata may include information regarding user profiles. The profile may include preference information (e.g., likes sports, hates comedies). Media control operations may be provided based on metadata relating to such user profiles. For example, whether a rewind option is provided may depend on the preferences of the user. In another example, if content is related to sports and a user profile indicates that such a user likes sports, the system may provide the rewind operation. However, if the content is related to comedy and the user profile indicates the user does not like comedy, then rewind operation may not be offered.

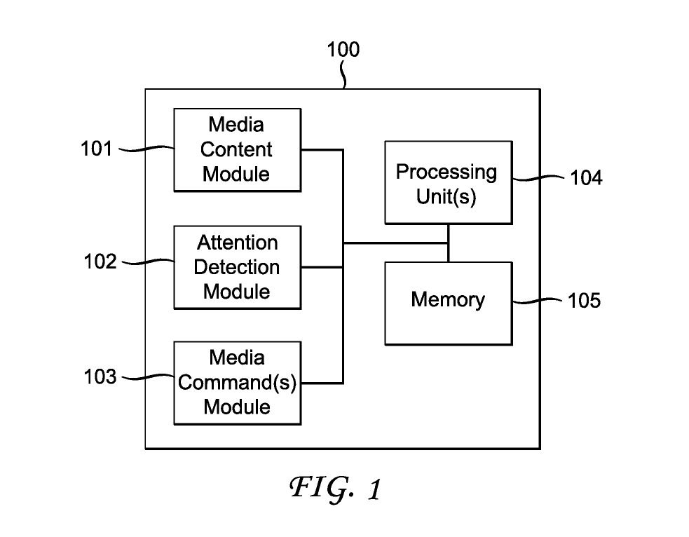

FIG. 1 illustrates a schematic diagram of a system 100 in accordance with present principles. The system 100 may be an apparatus (e.g., a device) or it may be composed of multiple devices or apparatus. The apparatus can comprise of any device capable of processing instructions and generating displayable images, including a set top box, a Blu-Ray player, a television, a smart television, a gaming console, a laptop, a full-sized personal computer, a smart phone, a tablet PC and the like. The system 100 may include media content module 101, attention detection module 102, media command(s) module 103, processing unit(s) 104, and memory 105.

The media content module 101 may receive media content from one or more sources. The media content may be transmitted via any communication medium including via broadcast (e.g., television and/or radio), wireless communications, cable, satellite broadcasting, Internet, or any other communication medium. The media content module 101 may receive media content from a broadcast affiliate manager, such as a national broadcast service, such as the American Broadcasting Company (ABC), National Broadcasting Company (NBC), Columbia Broadcasting System (CBS), or any other broadcasting service.

The media content module 101 may receive and pre-process media content data. The pre-processing may include converting data from an analog format to a digital format. The media content module 101 may further receive metadata, including time stamp information. The time stamps may identify the beginning and end of scenes or plots of media content. The metadata may also contain any other information described herein in accordance with present principles.

The media content module 101 may be an apparatus, device or the like. The media content module 101 may receive electrical signals, waves, or the like.

The attention detection module 102 may receive attention information. The attention information may relate to attention detection. The attention information may be related to the attention of one or more observers of media content. The attention information allows the determination of whether the observer has stopped, started or returned to observing the received media content. In one example, the attention detection module 102 may receive information that allows it to determine and/or recognize the loss or gain of an observer's attention. For example, the attention detection module 102 may track when a person entered or left an area and how such entry/exit point(s) map against the media content being displayed. In one example, the attention detection module 102 may include one or more sensors for sensing attention information (e.g., whether a user is observing the media content). Alternatively, the attention detection module 102 may receive information from sensors that are located externally to the system 100. The sensors may sense visual, audio and/or other information regarding media content observation. The sensor sources may include one or more of a camera, a detection unit, an image capture device, a motion sensing device, a heat sensing device, a biometric feedback device, and a microphone.

In one example, the attention detection module 102 may receive information about whether a user is within a room or an observation area. In one example, the attention detection module 102 may receive information from cameras that cover an area. The area may correspond to a field of view and/or hearing that resembles and/or replicates the normal viewing and/or hearing area of the media content.

In one example, the attention detection module 102 may receive biometric information of one or more media content observers. The biometric information may be received from any sources, such as a video camera, microphone, thermometer, and/or other biometric measurement devices. The attention detection module 102 may receive information regarding an observer's gaze (e.g., whether the gaze is wandering or is fixed on a viewing screen). The attention detection module 102 may receive information regarding the level of conversation in an area.

The attention detection module 102 may receive other biometric measurements, (e.g., temperature of users, pulse rate of users). The attention detection module 102 may receive other user information regarding observation of media content. This may include information relating to facial expressions, motions or other features for human recognition. For example, attention detection module 102 may determine attention information based on head orientation, eye direction tracking, and any other information relating to attention information.

In one example, the attention detection module 102 may determine the attention level of one or more observers based on the received information. Alternatively, the attention detection module 102 may transmit the received information to the processing unit(s) 104 for determinations regarding attention level(s).

The attention detection module 102 may further receive information for the creation of an attention event record. The record may be part of a log of records relating to attention information of observer(s). The attention detection module 102 may create the attention event record or may provide the information for creating the attention event record to processing unit(s) 104. The attention event record may include time stamps corresponding to the time the attention event was detected, media content identifying information (identifying the media content at that time), observer identifying information (identifying the observer whose gain or lack of attention was detected), and any other relevant metadata (e.g., scene metadata, genre of program, duration of program, starting time, ending time, show information, rerun or new release, critical scene or plot information, program quality indications, e.g., rating, film or television show information).

The attention detection module 102 may be an apparatus, device or the like. The attention detection module 102 may receive electrical signals, waves, or the like.

The media command(s) module 103 may receive media content operation commands. The media content operation commands may be received via a communication interface that receives commands from a user, (e.g., via a remote). The media command(s) module 103 can receive information from any input devices (e.g., of a keyboard, a mouse, a keypad, an image capture device, a motion sensing device, a microphone) via any medium. The media command(s) module 103 may receive information relating to the control of the operation of media content (e.g., commands relating to pause, rewind, fast-forward, and choose a certain timestamp).

The media command(s) module 103 may be an apparatus, device or the like. The media command(s) module 103 may receive electrical signals, waves, or the like.

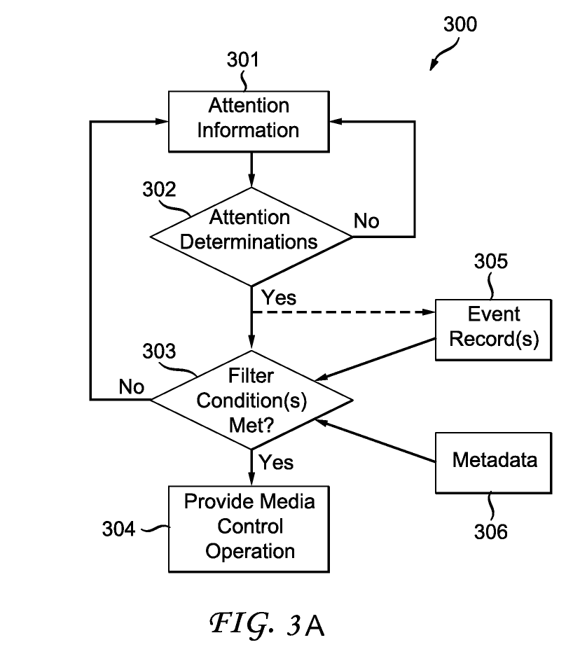

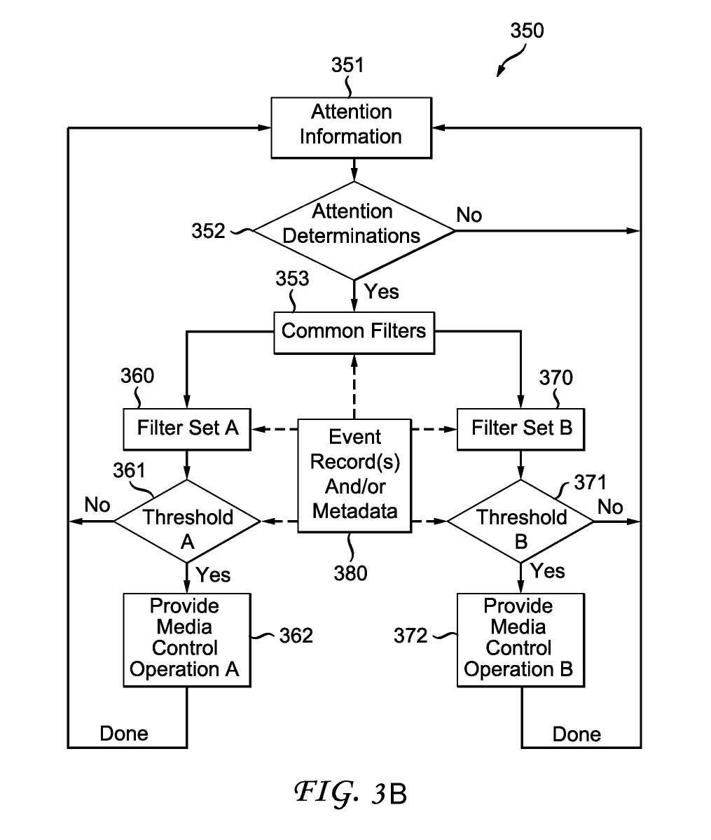

The processing unit(s) 104 include at least a processor (CPU) operatively coupled to other components via a system bus. The processing unit(s) 104 may process media content information received from the media content module 101, the attention detection module 102, and the media command(s) module 103. The processing unit(s) 104 may be configured to perform various processing operations in accordance with present principles by executing computer code. In one example, the processing unit(s) 104 may perform techniques described in connection with FIGS. 3-7. In one example, the processing unit(s) 104 may perform the processing for the operation of media content module 101, attention detection module 102, and/or media command(s) module 103.

In one example, the processing unit(s) 104 may perform attention determinations in accordance with present principles. The processing unit(s) 104 may perform processing operations relating to the determination of whether a user is observing media content. In one example, the processing unit(s) 104 may perform determinations for recognizing loss or gain of a user's attention. For example, the processing unit(s) 104 may perform determinations as to whether a person entered/left an area with a media player and how such entry/exit points map against the content being viewed. For example, the processing unit(s) 104 may determine if a sensed attention is above or below a threshold as to indicate gain of attention. In another example, the processing unit(s) 104 may determine if a sensed attention is above or below a threshold as to indicate loss of attention.

The processing unit(s) 104 may perform attention determinations based on sensed attention information. The processing unit(s) 104 may perform determinations based on received visual information, audio information, biometric measurements (e.g., information regarding a person's gaze, temperature, pulse), facial expressions, motions or other features for human recognition.

In one example, the processing unit(s) 104 may receive and process metadata relating to media content observers. The metadata may include information regarding user profiles associated with the observer(s). The profile may include preference information (e.g., likes sports, hates comedies). The metadata information may be stored in memory 105.

The processing unit(s) 104 may create attention detection event records. The processing unit(s) 104 may create an attention event record. The attention event record may include time stamps corresponding to the time the attention event was detected, media content identifying information (identifying the media content at that time), observer identifying information (identifying the observer whose gain or lack of attention was detected), and any other relevant metadata (e.g., scene metadata, genre of program, duration of program, starting time, ending time, show information, rerun or new release, critical scene or plot information, program quality indications, e.g., rating, film or television show information). The attention event records may be used as triggers for a filtering system that determines whether or not to offer a media control operation. The attention event records may be stored in the memory 105. The processing unit(s) 104 may use the attention event records as triggers for a filtering system that determines whether or not to offer a media control operation.

The processing unit(s) 104 may perform attention or filter determinations based on attention event records and/or additional metadata. For example, the processing unit(s) 104 may perform filter determinations based on one or more of: (i) a time duration that the observer(s) are not observing the media content; (ii) a number of observer(s) that are observing or are not observing the media content; (iii) a total number of observers observing the media content; (iv) a type of media content being provided during the time the observer(s) are not observing the media content; (v) time information (e.g., day of week, time of day); (vi) geographic information (e.g., location, weather); (vii) observer information (e.g., age, gestures, preferences, biometric information); (viii) auxiliary devices (e.g., phones, tablets) and the observer's interaction with such devices; (ix) display information (e.g., size); (x) observational patterns (e.g., total hours of content observed per day, average content observed per day). The processing unit(s) 104 may perform filter determinations for determining whether to offer a media control operation. The processing unit(s) 104 may perform filter determinations as described in connection with FIGS. 3-7.

In one example, the processing unit(s) 104 may further perform determinations based on metadata (e.g., user profiles, media content metadata). The processing unit(s) 104 may analyze metadata to determine whether to provide a media control operation. Such metadata may include time of day, day of week, weather condition, age or gender of viewers, size of viewing screen, hours of content consumed per day, geographical location, or any other observer information. For example, the processing unit(s) 104 may analyze metadata to determine a likelihood of returning to a particular scene which can be determine from prior data developed locally or from others consumption of the same content. A rewind media control operation may be provided if metadata indicates that an absent viewer missed information essential to a plot. In another example, a rewind media control operation may be provided based on a determination that the viewers are absent during a late time of day (e.g., after 9 p.m.). The processing unit(s) 104 may check a log of metadata for any high interest events. High interest events may include plot twists in a drama, plays or scoring events in sports content, and the like.

In another example, the processing unit(s) 104 may analyze metadata relating to user profiles. The profile may include preference information (e.g., likes sports, hates comedies). The processing unit(s) 104 may perform processing determinations based on the user preferences indicated in the user profiles. For example, if content is related to sports and a user profile indicates that such a user likes sports, the system may provide the rewind operation. However, if the content is related to comedy and the user profile indicates the user does not like comedy, then rewind operation may not be offered. That is, aspects of the content itself can determine whether or not the various media control operations takes place (e.g., if content is shorter than 30 minutes, the content is not rewound).

The processing unit(s) 104 may provide media content control operation(s). The providing may be either offering or activating of such media content. For example, the processing unit(s) 104 may offer for display options of media content control operation(s). In one example, the processing unit(s) 104 may provide for display suggestion of media control operations (e.g., rewind, pause, fast-forward, set media content to a certain time stamp). For example, the processing unit(s) 104 may provide for display an icon with a small image of the scene at the time a user left a room and an indication of a rewind option. The processing unit(s) 104 may further perform or activate the media control operations (e.g., rewind, pause, fast-forward, set media content to a certain time stamp). The processing unit(s) 104 may further optionally perform graphics processing, image, audio and/or video encoding/decoding, and audio encoding/decoding.

The memory 105 may be configured to store information received from one or more of the media content module 101, the attention detection module 102, and the media command(s) module 103. The memory 105 may be one or more of a variety of memory types. For example, the memory 105 may be one or more of an HDD, DRAM, cache, Read Only Memory (ROM), a Random Access Memory (RAM), disk storage device (e.g., a magnetic or optical disk storage device), a solid state magnetic device, and so forth.

The memory 105 may store computer executable instructions configured to perform techniques in accordance with FIGS. 3-7. The executable instructions are accessible by processing unit(s) 104 as stated above. The executable instructions may be stored in a random access memory (“RAM”) or can be stored in a non-transitory computer readable medium. Such non-transitory computer readable medium can comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that can be coupled directly or indirectly. The medium can also include any combination of one or more of the foregoing and/or other devices as well.

The memory 105 may further store time stamp information and/or attention detection event records. The memory 105 may further store attention related information, user related information (e.g., user profiles), media content related information and metadata related information. The memory 105 may further store metadata relating to observer or user information and/or preferences.

The system 100 may further include other elements (not shown), as readily contemplated by one of skill in the art, as well as omit certain elements. For example, various other input devices and/or output devices can be included, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

Further, it is to be appreciated that the system 100 may execute techniques disclosed herein. For example, the system 100 may perform in whole or in part one or more of the method(s) described in connection with FIGS. 3-7.

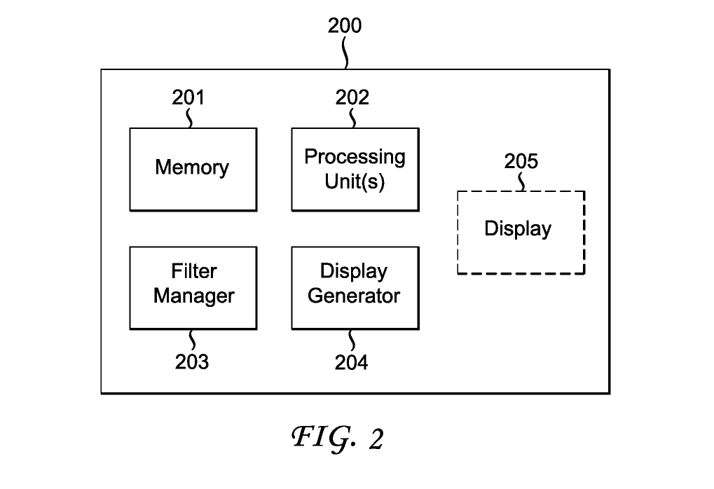

Moreover, it is to be appreciated that apparatus 200 described below with respect to FIG. 2 is an apparatus for implementing respective embodiments of the present principles. Part or all of device 200 may be implemented in one or more of the elements of system 100.

FIG. 2 illustrates a schematic diagram of an exemplary apparatus 200 for performing processing of media content control operations in accordance with present principles.

The apparatus 200 may be any device capable of processing instructions and generating displayable images, including, but not limited to, a set top box, a Blu-Ray player, a television, a smart television, a gaming console, a laptop, a personal computer, a smart phone, a tablet device and the like. The apparatus 200 may include memory 201, processing unit(s) 202, filter manager 203, display processor 204, and display 205.

The memory 201 may be a memory similar to the memory 105 described in connection with FIG. 1. For example, the memory 201 may store media content, attention, event record and metadata information. Likewise, the processing unit(s) 202 may be processing unit(s) similar to processing unit(s) 104 described in connection with FIG. 1.

The filter manager 203 may perform filtering processes in accordance with the principles described in connection with FIGS. 3-7. In one example, the filter manager 203 may perform the filtering processes utilizing the memory 201 and the processing unit(s) 202. In one example, the filter manager 203 may be implemented on the memory 201 and the processing unit(s) 202. The filter manager 203 may perform filtering operations in accordance with the principles described in connection with processing unit(s) 104 of FIG. 1.

The display processor 204 may generate for display media content control operations based on determinations by filter manager 203. In one example, the display processor 204 may generate information for display utilizing the memory 201 and the processing unit(s) 202. In one example, the display processor 204 may be implemented on the memory 201 and the processing unit(s) 202. The display processor 204 may perform operations in accordance with the principles described in connection with processing unit(s) 104 of FIG. 1.

While the display 205 is shown as part of the apparatus 200 in FIG. 2, in other examples the apparatus 200 may simply interact with the display 205, which can be part of a different system or device (such as a content consumption or content presentation device), coupled to apparatus 200 through an interface, and the like.

FIG. 3A illustrates a flow diagram of a method 300 for providing media content control operation(s) in accordance with present principles. The method 300 may be performed while media content is provided to a plurality of observers or users.

Method 300 includes a block 301 for receiving attention information. In one example, block 301 may receive information from any source (e.g., sensors, computing device(s)) via any medium (e.g., wired, wireless).

Block 301 may receive information relating to the attention of one or more media content observer(s) or user(s). In one example, block 301 may receive attention information for attention determinations (e.g., the loss, gain or return of attention) of one or more observer(s) or user(s). In another example, block 301 may receive raw data (e.g., sensor data) from which the attention information of one or more observer(s) or user(s) may be determined. In one example, block 301 may receive attention information described in connection with attention detection module 102 in FIG. 1.

In one example, block 301 may receive information relating to biometric feedback. For example, block 301 may receive information regarding a person's gaze, temperature, pulse rate, etc. In another example, block 301 may receive information relating to a user's facial expressions, motions or other features for human recognition. In one example, block 301 may further receive time stamp information. The time stamp information may correspond to event records, such as the event records described in connection with the attention detection module 102 in FIG. 1.

Block 302 may perform attention determinations based on the received attention. In one example, block 302 may determine whether there is loss, gain and/or return of attention of one or more observer(s) or user(s) of media content.

Block 302 may determine loss of attention such as leaving a room, leaving the close proximity of a display and/or a microphone, falling asleep, reading a book, etc. For example, block 302 may determine whether a user or observer has left a view area. Block 302 may track when a person entered/left an area with a media player and how such entry/exit points map against the content being viewed. Block 302 may likewise determine attention gain such as entering/returning to a room, entering/returning to the close proximity of a display and/or a microphone, shifting attention from another activity (e.g., sleeping, reading) to the media content. Block 302 may determine whether an observer's gaze is wandering or is fixed on a viewing screen.

In one example, block 302 may determine an attention value based on the attention information received from block 301. In one example, block 302 may determine a discrete attention value which can have different values corresponding to each viewer/consumer of content. For example, block 302 may increment by one the attention value for each gained observer and decrease the count by one for each lost observer. In another example, block 302 may determine a partial attention value for an observer based on the actions of the observer. For example, a partial attention loss may be signified by a shift of attention (e.g., sleeping, reading, observing other auxiliary devices, having conversations with other people). For example, a person's attention may be measured in fractional attention units (from 1.0 to 0.9 to 0.8 . . . to zero) for each observer whose attention has shifted. In one example, block 302 may determine attention values based on Tables 2-7.

In one example, block 302 may determine if there is an attention change. In one example, block 302 may determine the attention change based on the attention value. In one example, block 302 may compare the attention value to a threshold (e.g., to determine whether the attention value is above, equal to and/or below a threshold). Block 302 may also determine if there is a gain, loss or return of attention. Based on the determination of attention change, block 302 may then pass control to block 303.

Block 302 may trigger the creation of an event record, including time stamps identifying the time relating to the detected attention and/or the corresponding media content. The attention event record may be provided to block 305.

Block 303 may receive attention determinations from block 302. For example, block 303 may receive attention trigger information from block 302, such as a determination of attention change and/or the amount of attention change (e.g., the amount of attention gain, loss or return). In another example, block 303 may receive a binary (yes or no) indication that attention has been changed and/or the type of attention change (e.g., loss, gain, return).

Block 303 may perform analysis to determine whether to offer a media control operation. Block 303 may further determine which media content control operation should be offered. In one example, block 303 may filter unwanted interruptions in order to determine when to offer media control operations. In one example, block 303 may determine whether or not to offer a media control operation based on filter attention determinations.

Block 303 may perform filter attention determinations. Block 303 may determine whether to offer a media control operation based on the filter attention determinations. In one example, block 303 may perform determinations based on the attention determination (e.g., attention change such as the recognition of the loss, gain or return of attention of one or more observers of a group of multiple media content observers). Block 303 may perform filter determinations based on time stamp information. For example, block 303 may perform determinations based on time stamps stored with corresponding media content. The time stamps may be displayed with the media control operations. The time stamps may be further utilized to determine the time at which the media control operation should manipulate the media content. For example, the time stamp may indicate the time to which a video may be rewound. Block 303 may further use the time stamp information to classify media content and the times when an observer lost, gained and/or returned attention to the media content. Such times may be known as trigger points that may be classified by block 303 for use with the media control operations.

Block 303 may perform filter attention determinations based on event record information (e.g., a log) from block 305 and other metadata (e.g., metadata that is independent of the attention determinations) from block 306. For example, block 303 may evaluate one or more of: (i) a time duration that the observer(s) are not observing the media content; (ii) a number of observer(s) that are observing or are not observing the media content; (iii) a total number of observers observing the media content; (iv) type of media content being provided during the time the observer(s) are not observing the media content; (v) time information (e.g., day of week, time of day); (vi) geographic information (e.g., location, weather); (vii) observer information (e.g., age, gestures, preferences, biometric information); (viii) auxiliary devices within the observation area (e.g., phones, tablets) and the observer's interaction with such devices; (ix) display information (e.g., size); (x) observational patterns (e.g., total hours of content observed per day, average content observed per day). Block 303 may perform filter determinations based on the processes described in connection with FIGS. 3A and 4-7.

Block 305 may provide block 303 a log of attention event records. The event records may be based on various information, such as time stamps corresponding to the attention detection event, metadata, and observer identifying information. The records may contain time stamps that may be stored with corresponding attention event records. The event records may further include scene metadata. The time stamps and/or event records may be used as triggers for a filtering system that determines whether or not to offer a media control operation (e.g., a rewind offer). The event records may further contain observer identifying information associated with the attention event (e.g., information about the observer whose attention was gained and/or lost).

Block 306 may provide metadata (e.g., user profiles, media content metadata). For example, block 303 may analyze metadata from block 306 to determine whether to return to a particular scene. For example, a rewind media control operation may be provided if metadata indicates that an absent viewer missed information essential to a plot. Block 303 may analyze metadata to determine whether to provide a media control operation. Such metadata may include time of day, day of week, weather condition, age or gender of viewers, size of viewing screen, hours of TV watched per day, geographical location, etc. For example, a rewind media control operation may be provided based on a determination that the viewers are absent during a late time of day (e.g., after 9 p.m.). Based on a condition determination (e.g., such as when a viewer returns), block 303 may check a log of metadata for any high interest events. High interest events may include plot twists in a drama, plays or scoring events in sports content, and the like. Based on a determination of a high interest event scene within the metadata, block 303 may determine that a high likelihood exists for returning to the high interest event scene.

In another example, the metadata may relate to observer profiles. The profile may include preference information (e.g., likes sports, hates comedies). For example, whether a rewind option is provided may depend on the preferences of the user. For example, if content is related to sports and a user profile indicates that such a user likes sports, the system may provide the rewind operation. However, if the content is related to comedy and the user profile indicates the user does not like comedy, then a media control operation may not be offered.

In one example, block 303 may perform filter determinations based on the time duration of an observer's absence. The time duration information may be provided by block 305. Block 303 may determine not to offer a media control operation if the absence is short (e.g., below or equal to a threshold). Block 303 may determine not to offer a media control operation (e.g., a rewind operation) if the absence is long (e.g., above a threshold). Block 303 may further consider additional information, such as if the content shown during the absence is of little importance (in such case it may be determined not to offer a media control operation).

Block 303 may perform filter determinations based on the number of observers of media content. The number of observers may be provided by block 305. For example, block 303 may determine the type of media content operation that should be offered based on the number of people observing the media content. For example, when there are a low number of observers (e.g., two persons), block 303 may determine that a pause operation is most appropriate if one observer is no longer observing the media content. However, when the number of observers is above a threshold hold (e.g., five persons), block 303 may determine that a rewind operation should be offered at the time a user returns. For example, when there are only two persons observing the media content and when one person leaves and returns, the pause button provides the best way of dealing with the uncertainties of what's wanted. However, with a large group of people, a single person leaving should not inconvenience the group. In another example, block 303 may perform filter determinations based on the media content. For example, block 303 may perform filter determinations based on the media content that is displayed during a person's absence. In one example, block 303 may determine that a media control operation should not be offered if a scene or content type ends prior to an observer's return. If a type of content and/or a content scene ends before a person's return, block 303 may determine that the returning party lost interest in the content. If the media content is changed (e.g., a channel is changed, media content type is changed, the input source is changed), block 303 may also determine that a media content control operation may not be offered. Block 303 may determine that such a change, performed before the return of the observer, indicates that the original content is not of sufficient interest to the observer.

Block 303 may perform filter determinations based on additional detected information such as time information (e.g., day of week, time of day), geographic information (e.g., location, weather), observer information (e.g., age, gestures, preferences, biometric information), auxiliary devices within the observation area (e.g., phones, tablets) and the observer's interaction with such devices, display information (e.g., size), and observational patterns (e.g., total hours of content observed per day, average content observed per day, etc.). Block 303 may review the metadata from block 306 to perform such determinations. For example, block 303 may determine that a media control operation should not be offered if the time of day is late (e.g., after 11 pm). However, block 303 may determine to offer a media control operation if media content is being viewed during prime time (e.g., between 8-10 pm). In another example, block 303 may determine that a media control operation should be offered based on geographical information. For example, block 303 may offer a media content rewind operation if it determines that the media content is particularly relevant to the geographical region of where the observers are located. The geographical information may be provided by block 306.

In one example, block 303 may determine that a media control operation should be offered based on observer information (e.g., age, gestures, preferences, biometric information). The observer information may be part of the metadata provided by block 306. For example, block 303 may determine that a media control should be offered if the observer's gestures indicate that he is engaged in the program. Block 303 may determine that a media control should be offered if the program would be of particular to one of the age of the observer. Block 303 may determine that a media control should be offered if the observer's preferences indicate that he would be particularly interested in the program (e.g., if the observer's profile indicates a preference for sports and the media content is sports type programming).

Block 303 may determine that a media control should be provided if the observer's biometric indicate that he is engaged in the program (e.g., through an increased pulse rate). In another example, block 303 may determine that a media control should not be offered based on a determination of an observer's wandering interest (e.g., based a detection of the observer's gaze and/or increase in conversation level). If a person who leaves the room is determined to have had a low interest (e.g., biometric feedback indicated that the person was on the verge of falling asleep), than the media control operations may be inhibited when the person returns. Or, if the biometric feedback indicated a high level of viewer (e.g., rapid pulse, pupil dilation) interest while a viewer was out of the room, a media control operation (e.g., a rewind operation) may be offered when the viewer returns.

In one example, block 303 may determine whether a media control operation should be offered based auxiliary devices within the observation area (e.g., phones, tablets) and the observer's interaction with such devices. For example, block 303 may determine that a media control operation should not be offered if an observer begins to extensively interact with auxiliary devices. For example, block 303 may not offer a media control operation if an observer begins playing additional media content on a tablet.

In one example, block 303 may determine that a media control operation should be offered/activated based observational patterns (e.g., total hours of content observed per day, average content observed per day, etc.). For example, block 303 may offer a media content control operation for a user who has returned and who has a large amount of total hours of observed media content per day or who has a large amount of average time of observed media content.

Block 303 may determine whether to offer a media control operations based on Table 1:

TABLE 1

| | Condition | Condition |
|---|---|---|
| Filter Condition | Requirements | Determination |
| Number of | 1 person in room | inhibit |
| Observers | leaves then returns | |
| Number of | 2 people in room, 1 | allow |
| Observers | leaves then returns | |
| Number of | 4 people in room, 1 | inhibit |
| Observers | leaves then returns | |
| Time Duration of | less than 30 seconds | inhibit |
| Absence | | |
| Time Duration of | 30 seconds to 5 | allow |
| Absence | minutes | |
| Time Duration of | greater than 5 minutes | inhibit |
| Absence | | |
| content ends | before return | inhibit |
| content is changed | before return | inhibit |

In one example, the “condition determination” column of Table 1 may indicate whether a media control operation (e.g., a rewind, pause, time jump) is performed.

In another example, block 303 may determine whether to offer a media control operation based on the information in Tables 2-7 shown below. In one example, the “Attention determination” columns may correspond to an attention action or condition. The attention determination information may be received from block 302, from the event record log of block 305 and/or from the metadata block 306. The “Multiplier” column may correspond with a multiplier that will be multiplied with the number of observers that undertake the corresponding attention determination. In one example, the value resulting from multiplying the “multiplier” with the number of attention determination is the attention change value. The attention change value is then used to determine whether an attention change has occurred. If block 303 determines that an attention change has occurred, then it may pass control to block 304.

TABLE 2

| Attention determination | Multiplier |
|---|---|
| Person with eyes on TV | 1.0 |
| Person reading a book | 0.5 |
| Person sleeping | 0.2 |
| Adult watching children's program | 0.5 |
| Adult male watching ice hockey | 1.0 |
| Adult female watching ice hockey | 0.7 |
| Adult male watching romance movie | 0.7 |
| Adult female watching romance movie | 1.0 |

TABLE 3

| People in Room | Value |
|---|---|
| One Person | 0 |
| Two People | 1 |
| Three People | .75 |
| Four or More | 0 |

TABLE 4

| Attention Determination: Time since observer count decreased? | Value |
|---|---|
| Less than 30 seconds | 0 |
| 30 seconds to 5 minutes | 1 |
| 5 minutes to 15 minutes | .75 |
| Greater than 15 minutes | 0 |

TABLE 5

| Attention Determination: Has content ended? | Value |
|---|---|
| No | 1 |
| Yes | 0 |

TABLE 6

| Attention Determination: Content type | Value |
|---|---|
| Drama | 1 |
| Comedy | .7 |
| News | .6 |
| Sports | .5 |
| Other | .8 |

TABLE 7

| Attention Determination: Ratio of absence period to | |
|---|---|
| program duration | Value |
| Less than 4% | 0 |
| 4% to 8% | 1 |
| 8% to 15% | .75 |
| Greater than 15% | 0 |

Block 303 may further combine one or more filter condition determinations. For example, block 303 may further evaluate the combination of one or more filter condition determinations described above. For example, block 303 may determine whether a media control operation should be offered by an evaluation of multiple filter condition determinations. For example, each filter condition determination may be provided a value for a media control operation, and the values may be multiplied together to determine a total filter value. The filter value may then be compared to a threshold value to determine whether to provide a media control operation. In another example, certain filter condition determinations may be given higher priority or may override other filter condition determinations. For example, a determination to not offer a media control operation based on the duration of an absence may have a higher priority and may override a contradictory determination to offer a media control operation based on a content based determination.

Block 304 may provide for display media content operations based on the filter condition(s) determinations received from block 303. In one example, the block 304 may provide one or more of the following media control operation options: rewind, pause, fast forward, set media content to a specific time stamp, set media content to a specific scene. Block 304 may receive information from block 303 of the media control operation to be performed. In another example, block 304 may provide multiple media control operations for selection through interaction with a system. Block 304 may provide for display additional information besides the media control operation. For example, block 304 may provide for display an image corresponding to the time stamp of the media content to be displayed (e.g., a screenshot of scene). In one example, block 304 may determine to offer a media control operation. In another example, block 304 may automatically perform or activate any media control operation, such as a pause a volume limitation (e.g., lowering a volume), and/or an indication of the loss of attention.

FIG. 3B illustrates a flow diagram of a method 350 for providing media content control operation(s) in accordance with present principles. The method 350 may be performed while media content is provided to a plurality of observers or users.

The method 350 may include a block 351 for receiving attention information. In one example, block 351 may receive attention information in accordance with the principles described in connection with block 301 of FIG. 3A.

The method 350 may further include a block 352 for performing attention determinations. In one example, block 352 may perform attention determinations in accordance with the principles described in connection with block 302 of FIG. 3A. Block 352 may then determine if there is a gain, loss or return of attention. If block 352 determines there is an attention trigger (a YES determination), then it may pass control to block 353. If block 352 determines that there is not an attention trigger, then it may pass control back to block 351.

Block 353 may perform common filters determinations. In one example, the common filters of block 353 may be the filters and filter conditions described in connection with block 303 of FIG. 3A. In one example, block 353 may review event record log and/or metadata information form block 380 to determine if common filters should be applied. For example, block 353 may determine that a filter based on the duration of absence should be applied (e.g., Filter A). Block 353 may determine if additional filters should be applied, such as a filter based on the number of observers that have stopped observing the content (e.g., Filter B). Block 353 may determine that more than one filter should be applied. For example, block 353 may determine that additional filters, such as filters based on geographic location or time of day should be applied. Alternatively, block 353 may determine that only one filter should be applied. Block 353 may then pass control to the determined filter set(s), such as Filter Set A at block 360 or Filter Set B at block 370, both Filters A and B, and/or other Filters (C, D, . . . , etc.).

Block 360 may perform Filter Set A determinations. In one example, block 360 may assign an attention value to the filter set A in accordance with principles described in connection with FIG. 3A. Block 360 may then pass control to block 361.

Block 361 may compare the value determined block 360 with a threshold A. In one example, threshold A may be determined in accordance with Tables 2-7. If the value from block 360 determines an affirmative (YES) condition (e.g., the Filter Set A value is greater than equal to the threshold A), then block 361 may pass control to block 362. Otherwise, if block 360 determines a negative (NO) condition (e.g., the Filter Set A value is not greater than equal to the threshold A), then block 361 may pass control back to block 351.

Block 362 may provide a media control operation A. In one example, block 362 may provide a media control operation in accordance with the principles described in connection with block 304 of FIG. 3A.

Block 370 may perform Filter Set B determinations. In one example, block 370 may assign an attention value to the filter set B in accordance with principles described in connection with FIG. 3A. Block 370 may then pass control to block 371.

Block 371 may compare the value determined block 370 with a threshold B. In one example, threshold B may be determined in accordance with Tables 2-7. If the value from block 370 determines an affirmative (YES) value (e.g., the Filter Set B value is greater than equal to the threshold B), then block 361 may pass control to block 372. Otherwise, if block 370 determines a negative (NO) condition (e.g., the Filter Set B value is not greater than equal to the threshold B, then block 371 may pass control back to block 351.

Block 372 may provide a media control operation B. In one example, block 372 may provide a media control operation in accordance with the principles described in connection with block 304 of FIG. 3A. In one example, the media control operation B may be the same or different than the media control operation A of block 362. 3. In one example, block 372 may determine if a media control operation was already offered by another filter set. If a media control operation was already offered, block 372 may determine whether to offer any additional information based on the newly determined filter set (e.g., whether to offer a different media control operation, whether to stop offering the earlier media control operation, or whether to re-offer the media control operation).

In one example, the determinations of blocks 353, 360, 361, 362, 370, 371, and 372 may be based on information from event record and/or metadata block 380. Block 380 may correspond to blocks 305 and 306 described in connection with FIG.

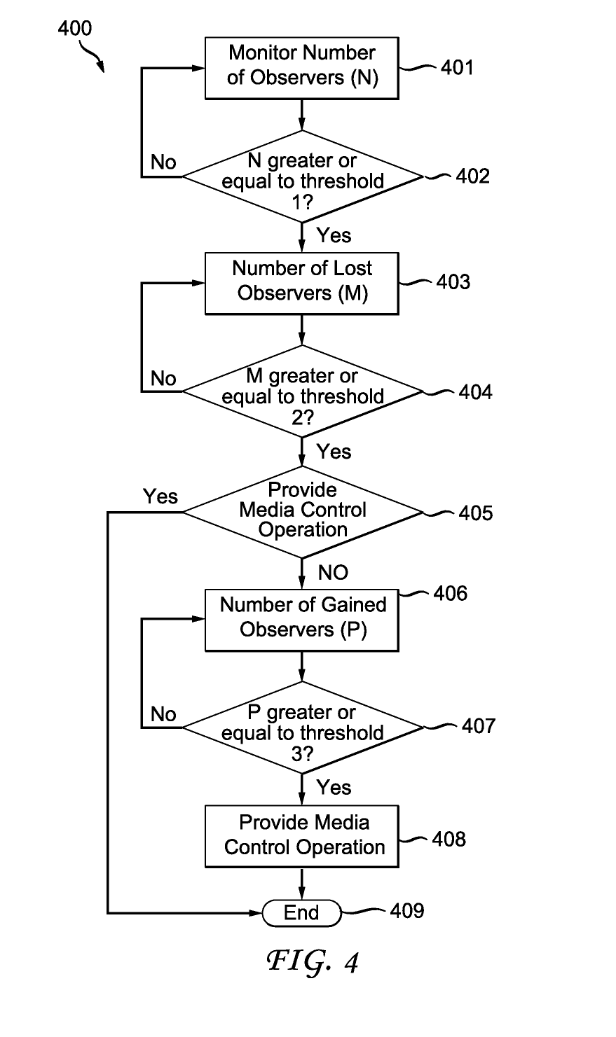

FIG. 4 illustrates a flow diagram of a method 400 in accordance with present principles. The method 400 may determine whether to provide a media control operation. The method 400 may be performed by method 300 of FIG. 3A, such as, for example, by blocks 303 and/or 302 of method 300.

The method 400 may include a block 401 for monitoring the number of observers of media content. Block 401 may receive attention information for determining the number of observers of media content. Block 401 may monitor the number of observers in an observation area (e.g., in a room or in a viewing or hearing area). The number of observers monitored by block 401 may be identified by a value N. Block 401 may monitor the value of N and provide such value of N to block 402.

Block 402 may determine if the value of N is greater or equal to a first threshold. For example, block 402 may determine if the value of N (the number of observers) is above or equal to the first threshold value, such as a threshold of two people. In another example, the first threshold may relate to an attention value that may be determined in accordance with Tables 2-7. This first threshold value signifies the minimum number of observers or attention that activates the system. If block 402 determines that the value of N is not greater than or equal to the first threshold, then it may return control to block 401 to continue monitoring the value of N. Otherwise, if block 402 determines that the value of N is greater than or equal to the first threshold, then it may pass control to block 403.

Block 403 may determine a number of lost observers. The number of lost observers may be identified by a value M. Block 403 may receive attention information for determining the number of lost observers of media content. Block 403 may track the number of observers who have left an observation area (e.g., a room or a viewing or hearing area). Alternatively, block 403 may determine how many observers have lost attention (e.g., turned away gaze, started observing auxiliary devices, indicated a change of attention through conversation level, lowered pulse indicating a person fell asleep). Block 403 may determine the value of M and provide the value of M to block 404.

Block 404 may determine if the value of M is greater or equal to a second threshold. For example, block 403 may determine if the value of M (the number of observers who have lost attention) is above or equal to the second threshold value, such as a threshold of two people. The second threshold value signifies the minimum number of observers or attention of observers that activates the system. An example of a second threshold would be two observers leave the room. Another example would be half of the observers leave. In another example, the second threshold value may relate to an attention value that may be determined in accordance with Tables 2-7. If block 404 determines that the value of M is not greater than the second threshold, then it may return control to block 403. Otherwise, if block 404 determines that the value of M is greater than or equal to the second threshold, then it may pass control to block 405.

Block 405 may determine whether to provide a media control operation. In one example, block 405 may determine to offer a media control operation based on the determination of the loss of attention at block 404. Block 406 may automatically activate any media control operation, such as a pause a volume limitation (e.g., lowering a volume), and/or an indication of the loss of attention.

Block 405 may offer for display an option for performing a media control operation (e.g., a pause function) based on the determination of loss of attention at block 404. In another example, block 405 may automatically perform/activate a media control operation (e.g., pause) based on the determination of loss of attention at block 404. If block 405 determines not to provide a media control operation, then it may pass control to block 406. If block 405 does decide to provide a media control operation, then it may provide control to an end block 409 which ends the method 400.

Block 406 may monitor the number of gained observers. The number of gained observers may be identified by a value P. The number of gained observers may correspond with the number of observers who have entered or returned to an observation area and/or returned their attention to media content. Block 406 may receive attention information for determining the number of gained observers of media content. Block 406 may track the number of gained observers. Block 406 may determine if an observer has entered an observation area (e.g., a room or a viewing or hearing area). Block 406 may then determine if the gained observer had previously left the observation area (thereby qualifying as a returned observer). In another example, block 406 may determine if an observer has started paying attention to media content and/or whether this observer is returning his or her attention to the media content. For example, block 406 may determine if an observer has returned his or her attention based on an analysis of their gaze and other biometric information. Block 406 may monitor the value of P and provide such value of P to block 407.

Block 407 may determine if the value of P is greater or equal to a third threshold. For example, block 407 may determine if the value of P (the number of observers who have gained attention) is above or equal to the third threshold value. The third threshold value may signify the minimum number of returned observers that may activate the system. In another example, the third threshold value may relate to an attention value that may be determined in accordance with Tables 2-7. If block 407 determines that the value of P is not greater than the third threshold, then it may return control to block 406. Otherwise, if block 407 determines that the value of P is greater than or equal to the third threshold, then it may pass control to block 408.

Block 408 may determine if it should provide a media control operation. In one example, block 408 may provide for display a media control operation based on the determination of the gain of attention at block 407. Block 408 may offer for display a suggestion of a media control operation (e.g., a rewind function, a pause function) based on the determination of gain of attention at block 407. In another example, block 408 may automatically perform/activate a media control operation (e.g., rewind) based on the determination of gain of attention at block 407. For example, if it is determined that a user has returned attention to the media content (e.g., has returned to a room where the media content is displayed), the block 408 may offer a rewind operation to the time the user lost attention to the media content. Block 408 may provide control to an end block 409 which ends the method 400.

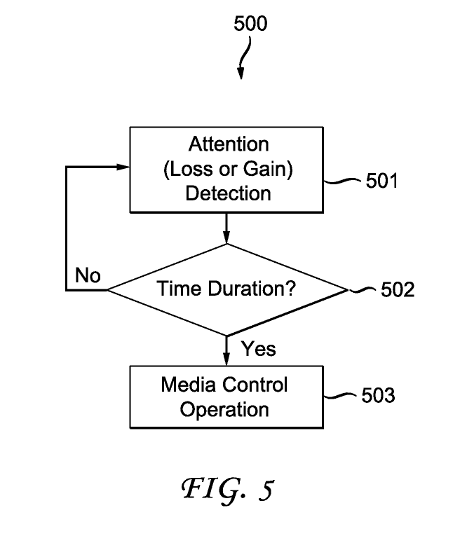

FIG. 5 illustrates a flow diagram of a method 500 in accordance with present principles. The method 500 may be performed by method 300 of FIG. 3A, such as, for example, by blocks 303 and/or 302.

The method 500 may include a block 501. Block 501 may detect attention events. For example, block 501 may determine if the attention of an observer has been lost, gained or returned. For example, block 501 may determine if an observer lost attention (e.g., by existing an observation area or by other indications such as a wandering gaze or falling asleep). Block 501 may detect attention events in accordance with the principles described in connection with blocks 301 and 302 of FIG. 3A. If an attention event is detected for one or more users, block 501 may pass control to block 502.

Block 502 may determine if a time duration meets a filter condition. Block 502 may determine if the attention gained or lost has occurred for at least a minimum amount of time. Block 502 may determine not to offer a media control operation if the absence is short (e.g., below or equal to a threshold) and/or if the content shown during the absence is of little importance. In one example, block 502 may perform time duration filter conditions based on the principles described in connection with FIG. 3A, including Table 4. Block 502 may determine to offer a media control operation (e.g., a rewind operation) if the absence is long (e.g., above a threshold). If block 502 determines to provide a media control operation (YES condition), then it passes control to block 503. Otherwise, if block 502 determines not to provide a media control operation (NO condition), then it passes control to block 501.

Block 503 may determine if it should provide a media control operation. In one example, block 503 may provide for display a media control operation based on the determination of block 502. Block 503 may offer for display a media control operation (e.g., a rewind function, a pause function) based on the determination of block 502. In another example, block 503 may automatically perform/activate a media control operation (e.g., pause, rewind) based on the determinations of block 502. For example, if block 502 determines that a user returned after a time duration that is between two time thresholds (e.g., less than 10 minutes but more than 2 minutes), block 503 may offer a rewind operation or jump back operation to the time stamp of the media content corresponding to the time the user left the observation area.

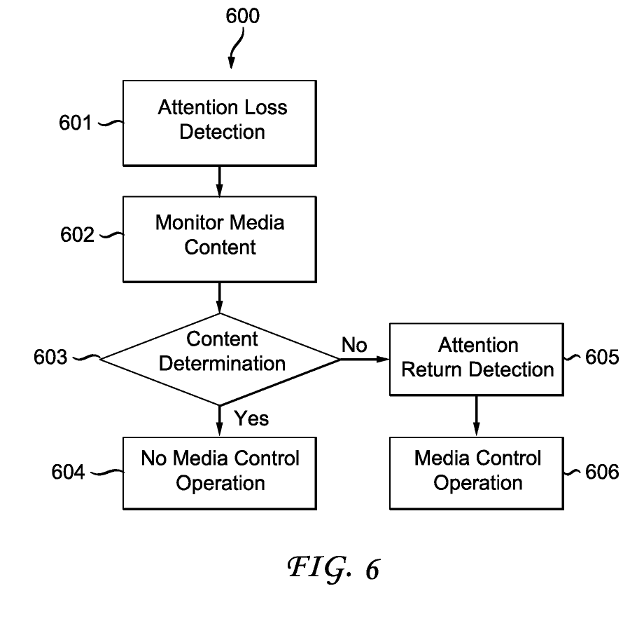

FIG. 6 illustrates a flow diagram of a method 600 for filter determinations in accordance with present principles. The method 600 may be performed by method 300 of FIG. 3A, such as, for example, by block 303.

The method 600 may include a block 601. Block 601 may detect attention loss events. Block 601 may determine attention loss in accordance with the principles described in connection with FIG. 3A, including blocks 301 and 302. For example, block 601 may determine if an observer lost attention by exiting an observation area or by other indications such as a wandering gaze or falling asleep. If an attention event is detected for one or more users, block 601 may pass control to block 602.

Block 602 may monitor media content after the detection event. Block 602 may provide information regarding the media content to block 603. Block 603 may perform media content determinations. In particular, block 603 may determine if a media content segment (e.g., plot or scene) has ended or if the media content has been changed. If block 603 determines that the media content segment has ended or that the media content has been changed (NO condition), then block 603 may pass control to block 604. Block 604 may indicate that a media control operation is not appropriate.

However, if block 603 determines that the media content segment has not ended or that the media content has not been changed (YES condition), then block 603 may pass control to block 605. Block 605 may determine if the attention of the observer has returned. If block 605 detects an attention detection return, then it may pass control to block 606.

Block 606 may determine if it should provide a media control operation. In one example, block 606 may provide for display a media control operation. Block 606 may offer a media control operation (e.g., a rewind function, a pause function). In another example, block 606 may automatically perform/activate a media control operation (e.g., pause, rewind).

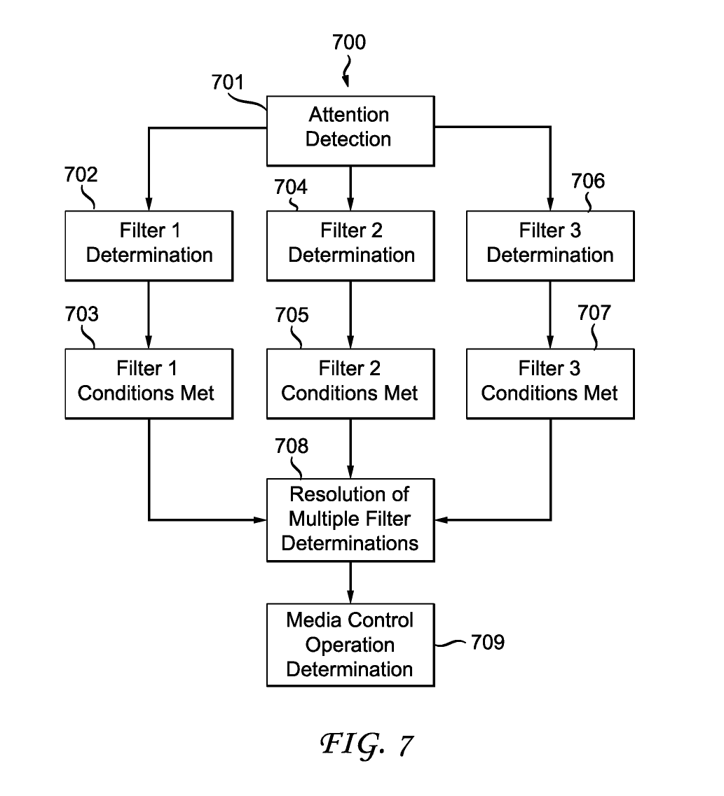

FIG. 7 illustrates a flow diagram of a method 700 for filter determinations in accordance with present principles. The method 700 may be performed by method 300 of FIG. 3A.

The method 700 may include a block 701. Block 701 may detect attention events. For example, block 701 may determine if the attention of an observer has been lost, gained or returned. Block 701 may determine attention events accordance with the principles described in connection with FIG. 3A, including blocks 301 and 302. If an attention event is detected for one or more users, block 701 may pass control to blocks 702, 704 and 706.

Block 702 may perform a filter 1 determination. For example, block 702 may perform a filter determination in accordance with the principles described in connection with block 303 of FIG. 3A. Alternatively, block 702 may perform a filter determination in accordance with the principles described in connection with method 400 of FIG. 4, method 500 of FIG. 5, or method 600 of FIG. 6. Block 702 may pass control to block 703 to determine whether a filter 1 condition is met. Block 703 may pass control to block 708 if it determines that a filter 1 condition is met.

Block 704 may perform a filter 2 determination. For example, block 704 may perform a filter determination in accordance with the principles described in connection with block 303 of FIG. 3A. Alternatively, block 704 may perform a filter determination in accordance with the principles described in connection with method 400 of FIG. 4, method 500 of FIG. 5, or method 600 of FIG. 6. Block 704 may pass control to block 705 to determine whether a filter 2 condition is met. Block 705 may pass control to block 708 if it determines that a filter 2 condition is met.

Block 706 may perform a filter 3 determination. For example, block 706 may perform a filter determination in accordance with the principles described in connection with block 303 of FIG. 3A. Alternatively, block 706 may perform a filter determination in accordance with the principles described in connection with method 400 of FIG. 4, method 500 of FIG. 5, or method 600 of FIG. 6. Block 706 may pass control to block 707 to determine whether a filter 2 condition is met. Block 707 may pass control to block 708 if it determines that a filter 3 condition is met.

Block 708 may determine if more than one filter condition was met. In one example, there may be less than three filters or there may be more than the three filters illustrated by blocks 702, 704 and 706. Block 708 may perform filter resolution by comparing different filter conditions. For example, there may be different scenarios for activating the media control operation. Block 708 may identify which if the scenarios are satisfied. In one example, block 708 may sum various values assigned to the filters of blocks 702, 704 and 706. For example, block 703 may sum the values discussed in connection with FIG. 3A. Block 703 may determine if the total value is greater than equal to a threshold. Based on affirmative determination, block 708 may pass control to block 709.

Block 709 may determine the media control operation to output based on the filter resolution determination of block 709. For example, block 709 may determine that no media control operation should be provided. Alternatively, block 709 may provide for display a media control operation. Block 709 may provide offer a media control operation (e.g., a rewind function, a pause function). In another example, block 709 may automatically perform/activate a media control operation (e.g., pause, rewind).

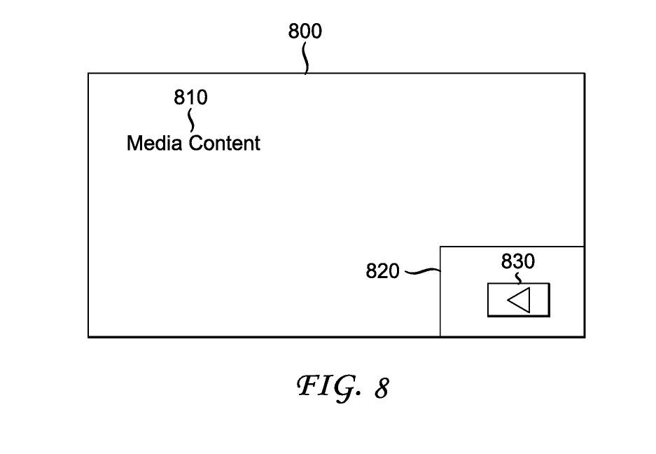

FIG. 8 is a schematic diagram of a user interface for displaying media content operation(s) in accordance with present principles. Specifically, FIG. 8 illustrates an exemplary user interface 800 in accordance with present principles. The user interface 800 includes a background area 810 in which the media content may be displayed. The user interface 800 may further include a media content control display area 820 in which a suggested media content control operation may be displayed and is offered in accordance with the presented principles. The display area 820 may display a button 830 which may illustrate the suggested media content control operation. In one example, the display area 820 may display in the background an image of the scene that was displayed at the time of the suggested media content control operation. While the areas 810 and 820 appear blank in FIG. 8 for the sake of clarity of illustration, it is presumed that media content may be displayed in one or more of these areas. While button 830 has been shown for exemplary purposes, it is to be appreciated that other control mechanisms can also be used to implement the present principles. In one example, control display areas 820 displays a graphic comporting to the media control operation being performed automatically in accordance with the presented principles.

Numerous specific details have been set forth herein to provide a thorough understanding of the present invention. It will be understood by those skilled in the art, however, that the examples above may be practiced without these specific details. In other instances, well-known operations, components and circuits have not been described in detail so as not to obscure the present invention. It can be appreciated that the specific structural and functional details disclosed herein may be representative and do not necessarily limit the scope of the present invention.

Various examples of the present invention may be implemented using hardware elements, software elements, or a combination of both. Some examples may be implemented, for example, using a computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

1. A method to perform at least one media control operation, the method comprising:
monitoring provided media content and attention information;
determining attention detection based on the attention information;
evaluating a filter condition based on the attention detection and additional attention information; and
providing the media control operation based on an affirmative determination of the filter condition.

2. The method of claim 1, further comprising displaying the media control operation.

3. The method of claim 1, wherein the additional attention information is at least one selected from the group of event record information and metadata.

4. The method of claim 3, wherein the event record information includes at least one selected from a group of: time duration, number of observers, type of media content, time information, biometric information, observational patterns, time information, display information, and auxiliary devices.

5. The method of claim 3, wherein the event record information includes at least an event record that includes at least one selected from the group of a time stamp relating to a time of the media content, the media content information at the time of the media content, and at least attention information of at least an observer at the time of the media content.

6. The method of claim 3, wherein the event record information includes a log of a plurality of event records, wherein the log is synchronized with each time stamp of each of the event records.

7. The method of claim 6, wherein the time stamps correspond to times during the media content when the observer gained or lost attention to the media content.

8. The method of claim 1, wherein the attention detection is based on a determination that the observer lost attention to the media content above a threshold.

9. The method of claim 3, wherein the filter condition is determined based on metadata, wherein the metadata is at least one selected from the group of time of day, day of week, weather condition, age or gender of viewers, size of viewing screen, hours of TV watched per day, geographical location, and preference profiles.

10. The method of claim 1, wherein the providing the media control operation is at least one selected from the group of offering or activating the media control operation.

11. A system to perform at least one media control operation, the system comprising:
a processing unit configured to monitor provided media content and attention information, the processing unit further configured to evaluate a filter condition based on attention detection and additional attention information; and
a memory configured to store information used by the processing unit;
wherein the attention detection is determined based on the attention information;
wherein the processing unit further provides the media control operation based on an affirmative determination of the filter condition.

12. The system of claim 11, further including a display processor to display the media control operation.

13. The system of claim 11, wherein the additional attention information is at least one selected from the group of event record information and metadata.

14. The system of claim 13, wherein the event record information includes at least one selected from a group of: time duration, number of observers, type of media content, time information, biometric information, observational patterns, time information, display information, and auxiliary devices.

15. The system of claim 13, wherein the event record information includes at least an event record that includes at least one selected from the group of a time stamp relating to a time of the media content, the media content information at the time of the media content, and at least attention information of at least an observer at the time of the media content.

16. The method of claim 13, wherein the event record information includes a log of a plurality of event records, wherein the log is synchronized with each time stamp of each of the event records.

17. The method of claim 16, wherein the time stamps correspond to times during the media content when the observer gained or lost attention to the media content.

18. The system of claim 11, wherein the attention detection is based on a determination that the observer lost attention to the media content above a threshold.

19. The system of claim 13, wherein the filter condition is determined based on metadata, wherein the metadata is at least one selected from the group of time of day, day of week, weather condition, age or gender of viewers, size of viewing screen, hours of TV watched per day, geographical location, and preference profiles.

20. The system of claim 11, wherein the providing the media control operation is at least one selected from the group of offering or activating the media control operation.

21. A non-transitory, tangible computer readable storage medium having computer executable code stored thereon to perform a method, the method comprising:
monitoring provided media content and attention information;
determining attention detection based on the attention information;
evaluating a filter condition based on the attention detection and additional attention information; and
providing the media control operation based on an affirmative determination of the filter condition.
